(19) United States
(12) Patent Application Publication
(10) Pub. No.: US 2007/0129993 A1
(43) Pub. Date: Jun. 7, 2007

(54) System and method for automated lead nurturing

(76) Inventor: Robert Alvin, Los Gatos, CA (US)

Correspondence Address: DAHYEE LAW GROUP, 24301 SOUTHLAND DR., SUITE 405, HAYWARD, CA, 94545, US

(21) Appl. No.: 11/607,346

(22) Filed: Dec. 1, 2006

Related U.S. Application Data
(60) Provisional application No. 60/741,560, filed on Dec. 2, 2005.

(51) Int. Cl. G07G 1/00

(52) U.S. Cl. 705/10

(57) ABSTRACT

A system for multi-level e-marketing and automatic nurturing leads comprises an application for defining the parameters of a marketing program, an application for automatically sending online offers to a selected list of leads, an application for extracting score factors from responses, an application for scheduling follow-up nurturing communications, and at least one database for storing rules and leads' scores and other information.

### REFERENCE TO RELATED APPLICATION

The present application claims priority to the provisional Appl. Ser. No. 60/741,560 filed on Dec. 2, 2005, the entire content of which is hereby incorporated by reference.

### FIELD OF THE INVENTION

The present invention relates in general to e-marketing, more particularly, to a system and method for automated lead nurturing in multi-level e-marketing.

### BACKGROUND OF THE INVENTION

E-marketing, also known as Internet marketing, usually refers to the marketing activities that occur online as opposed of offline, i.e. a company's efforts to communicate about, promote, and sell products and services over the Internet. E-marketing first began in the early 1990s as text-based websites that offered product information. It then evolved into advertisements complete with graphics and sophisticated hyperlinks. The most recent step in this evolution was the creation of complete online businesses that use the Internet to promote and sell their goods and services.

E-marketing is associated with various business models. The primary models include business-to-business (B2B) and business-to-consumer (B2C). B2B consists of companies doing business with each other, whereas B2C involves selling directly to the end consumers. When e-marketing began, the B2C model was first to emerge. B2B transactions were more complex and came about later. A third, less common business model is peer-to-peer (P2P), where individuals exchange items or files among themselves.

The benefits of e-marketing include the availability of information, promptness, greater audience reach, national or global market, and lower marketing program cost.

Various e-marketing software solutions have been developed- for online advertising and email campaigns incorporated with white paper and other content distribution services. Many marketers have to continually optimize their strategy to reach and obtain new prospects. Some B2B marketers are adding online content syndication to their lead-generation programs, as it can prove to be a winning solution allowing marketers to provide the sales team strong leads that have high potential of converting to customers. Using those solutions, however, marketers must often sacrifice quality in order to reach specific quantities of targeted prospects.

In addition, some major Web portals may offer plenty of traffic, but their targeting is unreliable at best, and further, they have limited contextually relevant content. Specialized portals may have slightly better targeting, but they are still limited to specific demographics or interests.

What is desired is a system with a high integrity for multi-level online lead generation in marketing services for B2B advertisers, marketers, and publishers.

### SUMMERY OF THE INVENTION

The present invention discloses a system for multi-level e-marketing and automatic nurturing leads, which includes (1) a software application for defining the parameters of a marketing program according the requirements and strategy, a software application for automatically sending form offers including these incorporated with emails to a selected list of leads according to machine-generated schedules; (2) a software application for extracting scoring factors from responses and prioritizing the scores according to a number of pre-defined data rules; (3) a software application for scheduling follow-up nurturing communications according to the algorithmic-generated schedules; and (4) at least one database for storing data rules and leads information such as scores.

The invention also includes a method for automated lead nurturing. The method includes the steps of:

(a) Launching a pre-defined marketing campaign to collect initial leads to put through into the lead nurturing system;

(b) Capturing the initial information about each lead who has responded;

(c) Extracting score factors from the initial information;

(d) Scheduling follow-up nurturing communications pursuant to each lead's score; and

(e) Send nurturing follow-up communications to each lead pursuant to the algorithmic-generated schedule based on timing and data rules

### BRIEF DESCRIPTION OF THE DRAWINGS

FIG. 1 is a schematic block diagram illustrating the system and method for multi-level e-marketing according to the present invention;

FIG. 2 includes tables 1-4 and the definitions illustrating a letter-number scoring system according to one of the preferred embodiments of the invention;

FIG. 3 is a schematic diagram illustrating the process of a three-level email launching program according to the invention; and

FIG. 4 is a block flow diagram illustrating the steps of the method for automated lead nurturing according to the invention.

### DETAILED DESCRIPTION OF THE PREFERRED EMBODIMENTS

While the present invention may be embodied in many different implementations or configurations, for the purpose of promoting an understanding of the principles of the invention, reference will now be made to the embodiments illustrated in the diagrams and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

Disclosed in the present invention is a multi-level e-marketing system for online lead generation and marketing services for B2B advertisers, marketers, and publishers. The system is powerful in delivering high-quality leads and maximizing the results of customer interactions, and enables highly effective marketing programs throughout the customer acquisition and relationship lifecycle.

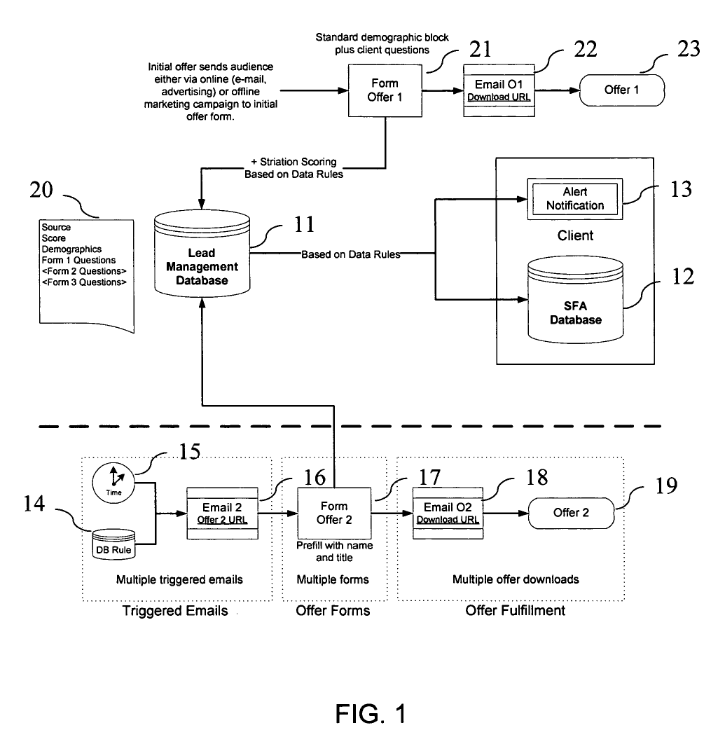

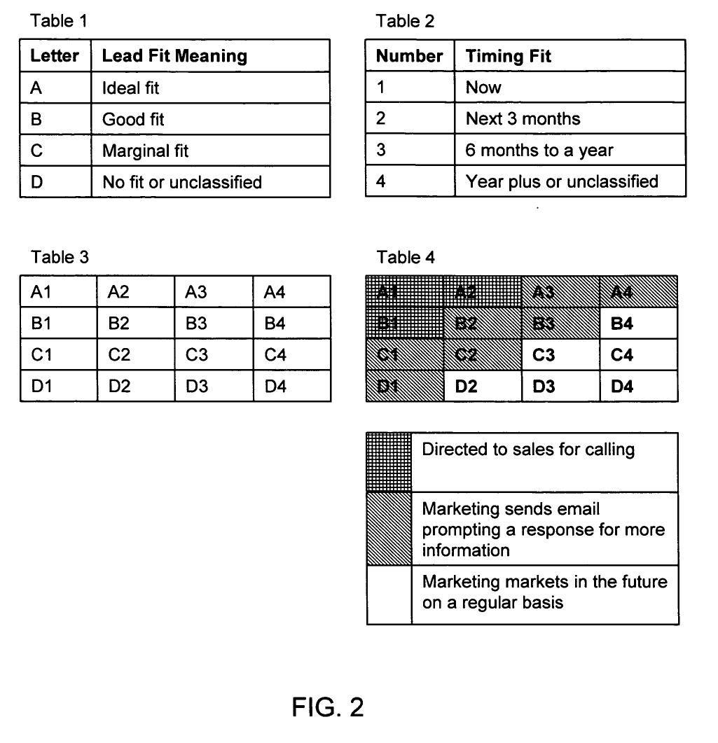

FIG. 1 is schematic block diagram illustrating the system for a typical automated lead nurturing package according to the preferred embodiment of the invention. The system includes a lead management database 11 for storing initial offer form information about leads such as email addresses and scores; a database 14 for storing rules for initiating subsequent nurturing communications including offer form and incentive offers; a sales force automation (SFA) or customer relationship management (CRM) database 12 for storing data rules for triggering the marketer's offline activities. To launch the lead nurturing program, an initial set of leads will be captured online and placed in the lead management database 11 by a user filling out an online form 21 which typically contains an incentive offer for content, software, or purchase specials. The captured initial information about the user is herein referred to as lead. For online fulfillment of the offer, an email 22, is typically sent to the lead providing him a link to download the offer 23. From the response, the system captures the initial lead information and generates the first lead score 20. A response may be an informative response by a reply, an ignorance (i.e. without opening at all), or click(s) without response. The lead score is primarily determined on the qualification relevancy and timing of a lead's need pursuant to their answers in the offer form 21. Using the lead score, the lead data entered on the initial offer form 21, the response information such as links clicked, and the time of occurrence, a pre-determined follow-up campaign can be then launched for the lead individual. The results of this follow-up campaign can be used to initiate the next campaign.

The automated lead nurturing system according to the present invention allows for the deployment of a multi-level lead nurturing program that consists of capturing initial information about the leads, scoring the lead, and subsequent follow-up multiple marketing communications. Once a marketing program has been defined and setup, online leads that have entered the program from an initial campaign launch will be further contacted through a series of relevant marketing communications designed to further engage and qualify the lead status, with a primary goal of moving qualifying leads up in status relevant to timing in purchasing of a product or service.

In the preferred embodiment of the present invention, the lead nurturing marketing program includes two steps. The first step in the process is to capture information about the initial lead through a series of specific questions on a web form 21, which sets up the initial “scoring factors” of the lead based on the responses provided, actions taken or not taken (e.g. links clicked), in conjunction with how the marketer has pre-defined the factors for determining the relevancy-timing score. The factors and the related rules and values are stored in the lead management database 14. Online offers may consist of advertisements in various media offering a white paper, a webinar, analysis briefs, participation in a survey, software, purchase specials and other promotions, through various online newsletters, ad sites, banner ads, and so on.

The next step is to define the extent of the follow-up program, herein referred to as “lead nurturing”, after the initial information has been extracted and scored. Lead nurturing consists of a number of multi-level email campaigns that might contain a combination of online forms for collecting further information, and the online fulfillment of incentive offers or additional promotion information. The database 14 stores information about the follow-up offer forms, emails and the rules for initiating nurturing communications. The database 14 is associated with a scheduling application 15 which triggers the launching of a subsequent campaign with the lead according to the lead's status. When the campaign is triggered, an email 16 is automatically delivered to the target lead. The email 16 includes or has a link to a new offer form 17, which may be pre-filled with the lead's name, title, other personalization information, plus allowance of additional questions. Upon clicking the link in the email 16, the lead is prompted with the second offer which requires the lead to fill out the form 17 which may include incentive offers. These offers may be fulfilled electronically via email 18 and a download 19 or fulfilled through typical offline means.

In addition, online prompts or electronic data interchange can occur to trigger offline activity using the database 12 and the associated alert notification application 13.

Examples of campaign components for the multi-level marketing program include, but are not limited to the following:
(1) Variable content emails;
(2) Online form to collect further information from the lead;
(3) Fulfillment of offline or online downloadable document(s), software or discount offers;
(4) Integration with other databases to trigger offline activities, such as postal mailing, salesperson notification to make a sales call, etc.; and
(5) Special alert emails to notify an individual or group about the status of a lead.

After a lead nurturing marketing program is defined according to the marketer's specific needs, lead scoring is to be determined. Lead scoring is an important feature of the lead nurturing system as illustrated in FIG. 1. It allows the marketer to generate a consistent quantitative value for the qualification of a lead that enters the program and updates this score when more information is gathered, or when a lead profile changes occur over time. Therefore, lead scoring is an essential component in deciding what action to take based on the responses from the lead.

In the typical embodiment of the invention, the lead score nomenclature given to a lead consists of a character pair, the first character represented by a letter, A through D, and the second represented by a number 1 through 4.

Table 1 illustrates a typical group of letter scores. The letter score identifies the relevancy, i.e., the fit of the lead to the marketer's objectives. A good fit for sales may be a lead from a company of a current size, a particular title, or a specific industry.

Table 2 illustrates a typical group of number scores. The number score identifies the timing, i.e. the timeliness of the lead potential for purchasing the product or service or to take the desired action. The time scoring reflects the lead's indication of a timeframe in making a sales decision.

Table 3 illustrates a 4×4 square matrix of letter-number scores. With a four value lead fit scoring and a four value lead timing scoring, 16 possible lead scores for all leads can be obtained and prioritized. The score of ‘A1’ indicates that a lead has an ideal fit for the sales objective and an immediate need, and thus this lead would require immediate attention. The order of the matrix can be any number.

Based on the e-marketers' marketing and sales strategy, each lead rating would be handled differently. In the following example as illustrated in Table 4, ‘A1’, ‘A2’, and ‘B1’ may be the leads that are handed directly to sales for a follow up call and may therefore generate an alert notification 13 as illustrated in FIG. 1.

After the leads are scored and prioritized according to the letter-number score system as illustrated in Table 1 and Table 2, and the data rules and timing for the program are provided to the system, the actions are scheduled automatically. The data rules are stored in the database 14, and the timing is controlled by the scheduling application 15. Based on available data and a delta of time, one or more of the above campaign components can be automatically triggered to occur based on the available data and data rules. In a typical lead nurturing program package as illustrated in FIG. 1, an online campaign is launched to capture the initial lead information and the first lead score is generated. Using the lead score, the lead data entered on the offer form, the response information such as links clicked, and the time of occurrence, a pre-determined follow-up campaign will be automatically launched for the lead individual. The results of this follow-up campaign can be used to automatically initiate the subsequent campaigns.

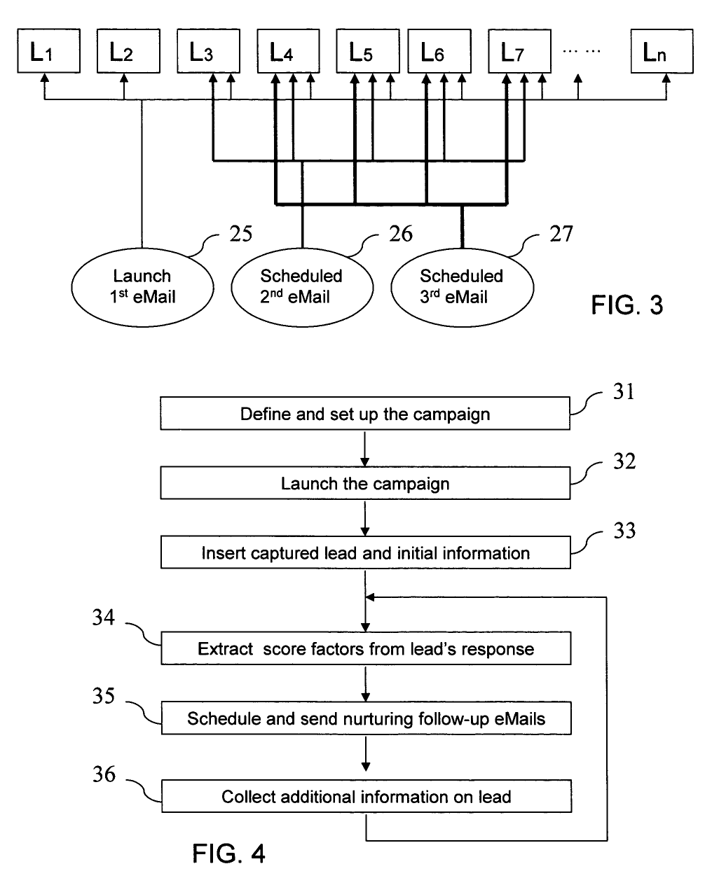

FIG. 3 is a schematic diagram illustrating the mechanism for the multi-level e-marketing according to the present invention. After a marketing program is well defined and set up by providing the scoring, data rules, timing, offer emails and form, the program is launched. The first email 25 will be sent to the pre-selected leads L1-Ln based on the rules and available data. Based on the responses received, the system automatically recalculates scoring data for each responded lead and schedules the subsequent nurturing communications. For example, the system automatically sends the second email 26 to leads L3-L7. Similarly, at a scheduled time, the system automatically sends the third email 27 to leads L4-L7.

FIG. 4 is a block flow diagram illustrating the steps for the multi-level e-marketing process:

Step 31: Define and set up the parameters for an e-marketing campaign. This includes the scoring rules, action rules based on the data, timing rules, and the actual online campaign material (emails, forms, downloadable content).

Step 32: Launch the campaign by releasing the rules and campaign materials to the software system (website, programs, and database).

Step 33: Insert captured lead information for leads who have responded to initial campaign.

Step 34: Automatically extract score factors from the initial information captured.

Step 35: Automatically schedule nurturing follow-up communications pursuant to each lead's score status and rules and send nurturing follow-up communications.

Step 36: Collect additional information about the leads from their actions based on the follow-up email and answers to additional offer forms.

The advantages of the system and method described above are numerous. First, by a one-time launch of a marketing program, the e-marketer actually harvests multi-level responses, can quantitatively measure the quality of the lead, maintain a personalized communication and complex interaction with multiple touch-points through out an extended period of time. Second, the follow-up nurturing marketing endeavors are automatically scheduled and executed by the system.

Although the invention is described herein with reference to the preferred embodiments, one skilled in the art will readily appreciate that other applications may be substituted for those set forth herein without departing from the spirit and scope of the present invention.

Accordingly, the invention should only be limited by the Claims included below.

1. In a computer network that includes at least two computers communicatively coupled to each other, a system for automated lead nurturing, comprising:
means for defining a marketing campaign;
means for launching said campaign by sending initial communication;
means for capturing information on a lead;
means for scoring said lead according to said lead's response and predefined data rules stored in a database;
means for scheduling subsequent nurturing communication according to said lead's score; and
means for sending scheduled subsequent nurturing communication.

2. The system of claim 1, wherein said capturing means comprises one or more questions proposed in an online form and at least one action to be taken.

3. The systems of claim 2, wherein said action is any of:
opening an email; or
clicking on a link.

4. The system of claim 1, wherein said capturing means comprises: means for extracting scoring factors from said response.

5. The system of claim 4, wherein said scoring factors are represented by a square matrix with columns of values for relevancy levels, and rows of values for timing levels.

6. The system of claim 5, wherein said square matrix is a 4 by 4 matrix.

7. The system of claim 4, wherein said scheduling means comprises:
means for triggering scheduled subsequent nurturing communication according to said lead's score;
means for triggering offline activities;
means for triggering special action in connection with one or more leads; and
means for making incentive offers;
wherein said subsequent nurturing communication comprise a combination of online forms for collecting further information.

8. The system of claim 7, wherein said scheduling means further comprises: means for initiating alert emails to notify one or more individuals of said lead's status.

9. In a computer network that includes at least two computers communicatively coupled to each other, a method for automated lead nurturing, comprising the steps of:
defining a marketing campaign;
launching said marketing campaign by sending initial communication;
capturing initial information on a lead;
scoring said lead according to said lead's response and one or more rules stored in a database;
scheduling subsequent nurturing communication according to said lead's score; and
sending scheduled subsequent nurturing communication.

10. The method of claim 9, wherein said initial communication comprises one or more questions proposed in an online form and at least one action to be taken.

11. The method of claim 10, wherein said action is any of:
opening an email; or
clicking on a link.

12. The method of claim 9, wherein said capturing step further comprises the step of:
extracting scoring factors from said lead's response.

13. The method of claim 12, wherein said scoring factors are represented by a square matrix with columns of values for relevancy levels, and rows of values for timing levels.

14. The method of claim 13, wherein said square matrix is 4 by 4 matrix.

15. The method of claim 12, wherein said scheduling steps further comprises the steps of:
triggering scheduled subsequent communication according to said lead's score;
triggering offline activities;
triggering special action in connection with one or more leads; and
making incentive offers;
wherein said subsequent nurturing communication comprises a combination of online forms for collecting further information.

16. The method of claim 15, wherein said scheduling steps further comprises the step of:
initiating alert emails to notify one or more individuals of a lead's status.

17. A method for providing e-marketing services, comprising the steps of:
(a) defining and setting up a marketing program;
(b) launching said program by sending initial communication;
(c) capturing initial information on a lead;
(d) scoring said lead according to said lead's initial response and data rules;
(e) scheduling subsequent nurturing e-mail according to said lead's score; and
(f) sending scheduled subsequent nurturing e-mail;
(g) recapturing further information on said lead according said lead's new response;
(h) updating said lead's score;
(i) rescheduling subsequent nurturing e-mail according to said updated score;
(j) sending newly scheduled nurturing e-mail; and
(k) repeating the steps (g) through (j).

18. The method of claim 17, wherein said initial communication comprises one or more questions proposed in an online form and at least one action to be taken.

19. The method of 17, further comprising the steps of:
triggering offline activities according to said lead's score;
triggering special action in connection with one or more leads; and making incentive offers.

20. The method of claim 17, further comprising the step of: initiating alert email notice about a lead's status.
